(19) United States
(12) Patent Application Publication
(10) Pub. No.: US 2008/0238908 A1
(43) Pub. Date: Oct. 2, 2008

(54) Driving circuit device of plasma display panel and plasma display apparatus

(76) Inventors: Tetsuya Sakamoto, Yokohama (JP); Akira Otsuka, Zama (JP); Akihiro Takagi, Kawaguchi (JP); Shigetoshi Tomio, Yokohama (JP)

Correspondence Address: MCDERMOTT WILL & EMERY LLP, 600 13TH STREET, N.W., WASHINGTON, DC, 20005-3096, US

(21) Appl. No.: 11/896,474

(22) Filed: Aug. 31, 2007

(30) Foreign Application Priority Data
Mar. 26, 2007 (JP) JP 2007-78994

(51) Int. Cl. G09G 5/00

(52) U.S. Cl. 345/211; 345/204; 345/60

(57) ABSTRACT

In this PDP apparatus, in a sustain driving circuit device for supplying sustain discharge pulses, an energy recovery circuit has a coil, switches, and diodes, and a Vs clamp circuit has switches. In the energy recovery circuit, the switches are connected to a panel capacitor, and the coil is connected to a power source line with an intermediate potential of Vs, and a clamp diode and a power source connected thereto are connected to a node between the coil and the switch. As a control timing, at a timing of less than π/2 of an LC resonance current cycle, the switch of the energy recovery circuit is turned OFF and then the switch of the Vs clamp circuit is turned ON, thereby performing the Vs clamp.

### CROSS-REFERENCE TO RELATED APPLICATION

The present application claims priority from Japanese Patent Application No. JP 2007-078994 filed on Mar. 26, 2007, the content of which is hereby incorporated by reference into this application.

### TECHNICAL FIELD OF THE INVENTION

The present invention relates to a plasma display apparatus (PDP apparatus) having a plasma display panel (PDP) and a driving circuit device thereof. More particularly, the present invention relates to a driving circuit for outputting sustain discharge pulses (sustain pulses).

### BACKGROUND OF THE INVENTION

Conventionally, a driving circuit of PDP apparatus has a sustain discharge pulse driving circuit (abbreviated as sustain driving circuit) including an energy recovery circuit and a sustain discharge voltage (referred to as Vs) clamp circuit. The sustain driving circuit supplies sustain discharge pulses to the electrodes (display electrodes, that is, sustain (X) electrodes or scan (Y) electrodes) used for the sustain discharge of a panel (PDP). In the energy recovery circuit, by the LC resonance of the capacitor (C) between the electrodes (X, Y) of a panel and the inductance (L) of a coil, the power accumulated in the panel capacitor (C) is recovered. The Vs clamp circuit has switches (referred to as SC) for controlling the operation of clamping to high potential (v1) and low potential (v2) of the sustain discharge pulse, respectively. Further, the voltage of the sustain discharge pulse (difference between high potential (v1) and low potential (v2)) is referred to as sustain discharge voltage (Vs). Also, firing voltage (Vi) in the sustain discharge by the sustain discharge pulse is slightly lower than the sustain discharge voltage (Vs).

### SUMMARY OF THE INVENTION

In the sustain driving circuit described above in the background of the invention, when supplying the voltage higher than the firing voltage (Vi) from the energy recovery circuit (including coil (L)) to the panel electrode (capacitor (C)), the operation as follows is performed. That is, since sufficient gas discharge current cannot be supplied to the capacitor (C) because the impedance of the circuit (including coil (L)) is high, voltage is supplied from the Vs clamp circuit in order to perform the stable sustain discharge in the capacitor (C). Note that the gas discharge indicates the discharge in the panel capacitor (C), that is, the discharge between the electrodes of the display cells, in particular, it indicates the sustain discharge generated between the display electrodes (X, Y) by the application of the sustain discharge pulses.

When the sustain discharge pulses are supplied to the panel electrodes (capacitor (C)) by the energy recovery circuit and the Vs clamp circuit in the sustain driving circuit, the coil (L) and the capacitor (C) or the coil (L) and the Vs clamp circuit are always in an electrically conducting state (not in a shut-off state). Therefore, since the current flowing in the coil (L) cannot be controlled, the circuit operation is unstable.

The present invention has been made considering the problems as described above, and an object of the present invention is to provide a technology capable of achieving the stable circuit operation of a driving circuit (sustain driving circuit) of PDP apparatus.

The typical ones of the inventions disclosed in this application will be briefly described as follows. For the achievement of the object described above, the present invention provides a technology for a PDP driving circuit device which drives the electrodes of a PDP (panel) by applying voltage waveforms in PDP apparatus having an AC-driven PDP, in particular, a technology for a sustain discharge pulse driving circuit (sustain driving circuit) which supplies sustain discharge pulses to electrodes (X electrodes or Y electrodes) used for the sustain discharge of a panel, and it is characterized by the structure described below.

The PDP driving circuit device according to the present invention comprises means and characteristics shown in (1) and (2) below. First, (1) in the operation and the control of the LC resonance in an energy recovery circuit in a sustain driving circuit, the structure for electrically separating a coil (L) side and a panel capacitor (C) side, that is, the structure in which the conducting state and the non-conducting state therebetween can be controlled by a switch is provided. Further, in this device, (2) the technology for improving the display quality (driving margin) by the operation in which, according to the well-known technology of the early clamp operation control, that is, by hastening the timing of the Vs clamp from the conventional one, the Vs clamp is performed at the timing earlier than the timing of reaching the predetermined voltage by the LC resonance is used together with (1) described above.

In this sustain driving circuit, with regard to the characteristic of (1) described above, the Vs clamp circuit is connected to the panel electrode side (similar to conventional), and in the energy recovery circuit, a switch (SL) and a diode (DL) for energy recovery (for controlling LC resonance operation) are provided between the coil (L) for energy recovery and the panel electrode (capacitor (C)). In other words, this sustain driving circuit differs from the conventional one in the arrangement of the coil (L) and the switch (SL).

Further, in the energy recovery circuit, a line having a diode for clamp (clamp diode) (DC) and a power source (Vc) connected thereto in the energy recovery circuit is connected to a node between one end of the coil (L) and the diode (DL) or the switch (SL). The other end of the coil (L) is connected to a side of a power source line having the almost intermediate potential of Vs. As the power source (Vc) of the energy recovery circuit, power sources having the voltage absolute values equal to or lower than those of the power sources for sustain discharge of the Vs clamp circuit (power source (V1) corresponding to high potential (v1) of the sustain discharge pulse and power source (V2) corresponding to low potential (v2) thereof) are used.

The driving circuit device of the PDP apparatus has the structure as follows. The sustain driving circuit provided in the driving circuit device has an energy recovery circuit and a Vs clamp circuit connected to electrodes used for the sustain discharge in a panel. In the sustain driving circuit, the energy recovery circuit has a coil (L), first-type switches (SL) for the control of the LC resonance operation, and first-type diodes (DL) for the rectification of the LC resonance operation, and it performs the operation of recovering the power charged and accumulated in the capacitor (C) by the LC resonance of the inductance (also denoted by L) of the coil (L) and the capacitor (C) between the panel electrodes. First-type power sources (V1, V2) corresponding to high potential (v1) and low potential (v2) of the sustain discharge pulse are connected in the Vs clamp circuit, and the Vs clamp circuit has second-type switches (SC) for controlling the operation (Vs clamp operation) of clamping to the high potential (v1) and the low potential (v2) of the sustain discharge pulse, respectively. As the structure for arranging circuit components in the energy recovery circuit, one end of the coil is connected to the panel electrode via the first-type diodes (DL) and the first-type switches (SL), and lines each having the second-type diode (DC) for clamp (clamp diode) and the second-type power source (Vc) connected thereto in the energy recovery circuit are connected to the nodes between the one end of the coil and the first-type switches (SL). The other end of the coil is connected to a power source line having the almost intermediate potential of the sustain discharge voltage (Vs) applied between the electrodes of the panel capacitor (C), that is, the voltage (Vs) of the difference between the high potential (v1) and the low potential (v2) of the sustain discharge pulse (in the structure where v1 and v2 are ±Vs/2, GND). Alternatively, in the structure where v1 and v2 are Vs and GND, respectively, as the power source line having the almost intermediate potential, it is connected to the other end of the condenser (Cp) for energy recovery whose one end is connected to GND.

Further, in this driving circuit device, as the operation control including the early clamp operation control when applying the sustain discharge pulse with regard to the characteristic of (2) described above, first, in the state where the second-type switch (SC) of the Vs clamp circuit is turned OFF (step 0), the first-type switch (SL) of the energy recovery circuit is turned ON (step 1), thereby causing the LC resonance. Then, the first-type switch (SL) is turned OFF at the timing of π/4 or more and less than π/2 of the LC resonance current cycle (step 3), and subsequently, the second-type switch (SC) is turned ON (step 4), thereby clamping to the high potential (v1) or the low potential (v2) of Vs.

Also, in this driving circuit device, a first coil (L1) used when supplying current from the energy recovery circuit to the panel electrode by the LC resonance operation and a second coil (L2) used when supplying current from the panel electrode to the energy recovery circuit are provided on parallel lines as the coil (L) in the energy recovery circuit. Further, a first switch (SLu) on a charge side to the capacitor (C) and a second switch (SLd) on a discharge side from the capacitor (C) are provided as the first-type switch (SL). Further, a first diode (DLu) on a charge side to the capacitor (C) and a second diode (DLd) on a discharge side from the capacitor (C) are provided as the first-type diode (DL). Further, a first power source on high potential side (Vc1) which is lower than the voltage of the first power source (V1) corresponding to the high potential of Vs (v1, for example, +Vs/2) and equal to or higher than the intermediate potential of Vs (vm, for example, GND) (vm≦Vc1<v1) and a second power source on low potential side (Vc2) which is higher than the voltage of the second power source (V2) corresponding to the low potential of Vs (v2, for example, −Vs/2) and equal to or lower than the intermediate potential of Vs (vm, for example, GND) (v2≦Vc2<vm) are provided as the second-type power source (Vc) connected to the second-type diode (DC). Further, as the second-type diode (DC), a first diode (DC1) for clamping to the voltage of the first power source (Vc1) of the second-type power source (Vc) is connected to the node between the first coil (L1) and the first diode (DLu) or the first switch (SLu), and the second diode (DC2) for clamping to the voltage of the second power source (Vc2) of the second-type power source (Vc) is connected to the node between the second coil (L2) and the second diode (DLd) or the second switch (SLd).

The effects obtained by typical aspects of the present invention will be briefly described below. According to the present invention, it is possible to achieve the stable circuit operation of a driving circuit (sustain driving circuit) of PDP apparatus.

### BRIEF DESCRIPTIONS OF THE DRAWINGS

FIG. 1 is a diagram showing the entire structure of PDP apparatus according to an embodiment of the present invention;

FIG. 2 is a diagram showing an example of the structure of a PDP in the PDP apparatus according to the embodiment of the present invention;

FIG. 3 is a diagram showing a structure of a sustain discharge pulse driving circuit (first structure example) in PDP apparatus according to the first embodiment of the present invention;

FIG. 4 is a diagram showing a structure of a sustain discharge pulse driving circuit (second structure example) in PDP apparatus according to the second embodiment of the present invention;

FIG. 5 is a diagram showing another structure of the sustain discharge pulse driving circuit (third structure example) in the PDP apparatus according to the second embodiment of the present invention;

FIG. 6A is a diagram showing waveforms for control timing of a sustain discharge pulse driving circuit in the PDP apparatus according to the second and third embodiments of the present invention;

FIG. 6B is a diagram showing waveforms of output currents in the sustain discharge pulse driving circuit in the PDP apparatus according to the second and third embodiments of the present invention;

FIG. 6C is a diagram showing waveforms of output currents in the sustain discharge pulse driving circuit in the PDP apparatus according to the second and third embodiments of the present invention;

FIG. 7 is a diagram showing a structure of a sustain discharge pulse driving circuit (fourth structure example) in PDP apparatus according to the third embodiment of the present invention;

FIG. 8 is a diagram showing another structure of the sustain discharge pulse driving circuit (fifth structure example) in the PDP apparatus according to the third embodiment of the present invention;

FIG. 9 is a diagram showing a structure of a sustain discharge pulse driving circuit (sixth structure example) in PDP apparatus according to the fourth embodiment of the present invention;

FIG. 10 is a diagram showing another structure of the sustain discharge pulse driving circuit (seventh structure example) in the PDP apparatus according to the fourth embodiment of the present invention;

FIG. 11A is a diagram showing waveforms for control timing of a sustain discharge pulse driving circuit in the PDP apparatus according to the fourth embodiment of the present invention;

FIG. 11B is a diagram showing waveforms of output currents in the sustain discharge pulse driving circuit in the PDP apparatus according to the fourth embodiment of the present invention;

FIG. 12A is a diagram showing waveforms for control timing of a sustain discharge pulse driving circuit in a modified example of the PDP apparatus of the second and third embodiments of the present invention;

FIG. 12B is a diagram showing waveforms of output currents in the sustain discharge pulse driving circuit in the modified example of the PDP apparatus of the second and third embodiments of the present invention;

FIG. 12C is a diagram showing waveforms of output currents in the sustain discharge pulse driving circuit in the modified example of the PDP apparatus of the second and third embodiments of the present invention; and

FIG. 13 is a diagram showing a structure example of a sustain driving circuit of PDP apparatus according to the conventional technology.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

<Conventional Technology>

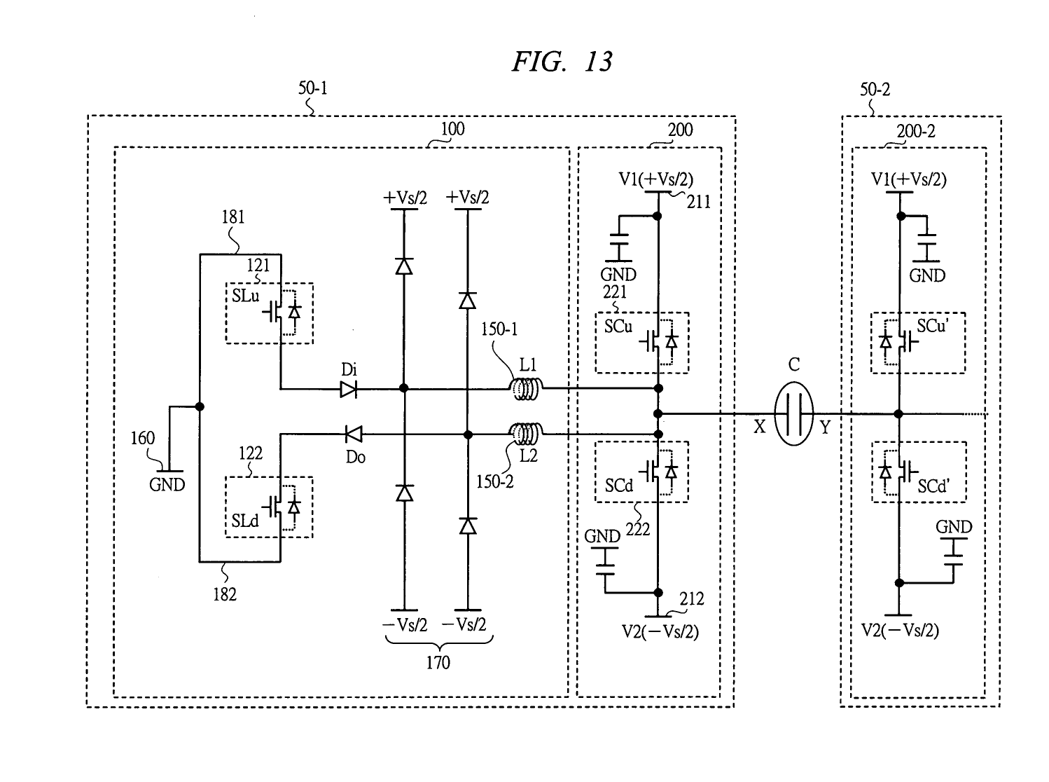

The sustain driving circuit as the conventional technology of the embodiments of the present invention will be described in brief with reference to FIG. 13 in order to make the description of the embodiments of the present invention easy to understand.

In FIG. 13, a sustain driving circuit 50-1 has an energy recovery circuit 100 and a Vs clamp circuit 200, and it is connected to an X electrode of a panel capacitor (C). Also, a sustain driving circuit 50-2 having a Vs clamp circuit 200-2 with the similar structure is connected to a Y electrode of the panel capacitor (C).

In the Vs clamp circuit 200, a first power source (V1) 211 on a high-potential (v1) side and a second power source (V2) 212 on a low-potential (v2) side corresponding to a sustain discharge pulse and sustain discharge voltage (Vs) are connected, and as a circuit of a switch (SC) for controlling the operation of the Vs clamp, a first switch (SCu) 221 and a second switch (SCd) 222 are provided. The first switch (SCu) 221 is used for the Vs-clamp-up operation control, and the second switch (SCd) 222 is used for the Vs-clamp-down operation control. The same is true of the switches on the Y side (SCu′ and SCd′). Each of the switches (SC, SL) includes a switch element such as FET (Field Effect Transistor).

The energy recovery circuit 100 has a first coil (L1) 150-1 and a second coil (L2) 150-2 as the coil (L) for energy recovery, and has a first switch (SLu) 121 and a second switch (SLd) 122 as a circuit of the switch (SL) for controlling the LC resonance operation. The first switch (SLu) 121 is used for controlling the LC-resonance-up operation, and the second switch (SLd) 122 is used for controlling the LC-resonance-down operation. Further, in the energy recovery circuit 100, clamp diodes and power sources 170 are connected.

On a first line (181) on a charge (charge supply) side from the energy recovery circuit 100 to the panel capacitor (C), the first coil (L1) 150-1 is connected to a side close to the panel electrode and the Vs clamp circuit 200. Further, on a second line (182) on a discharge (charge recovery) side from the panel capacitor (C) to the energy recovery circuit 100, the second coil (L2) 150-2 is connected to a side close to the panel electrode. Meanwhile, with regard to the switch (SL), the switch (SLu) 121 and the switch (SLd) 122 are connected to a side close to the power source line 160.

In the conventional technology, when supplying the voltage higher than the firing voltage (Vi) from the energy recovery circuit 100 to the panel electrode (capacitor (C)), the operation as follows is performed. That is, since sufficient gas discharge current cannot be supplied to the capacitor (C) because the impedance of the circuit (including coil (L)) is high, voltage is supplied from the Vs clamp circuit 200 in order to perform the stable sustain discharge in the capacitor (C). When the sustain discharge pulses are supplied to the panel electrodes (capacitor (C)) by the energy recovery circuit 100 and the Vs clamp circuit 200, the coil (L) and the capacitor (C) or the coil (L) and the Vs clamp circuit 200 are always in an electrically conducting state. Therefore, the current flowing in the coil (L) cannot be controlled.

### First Embodiment

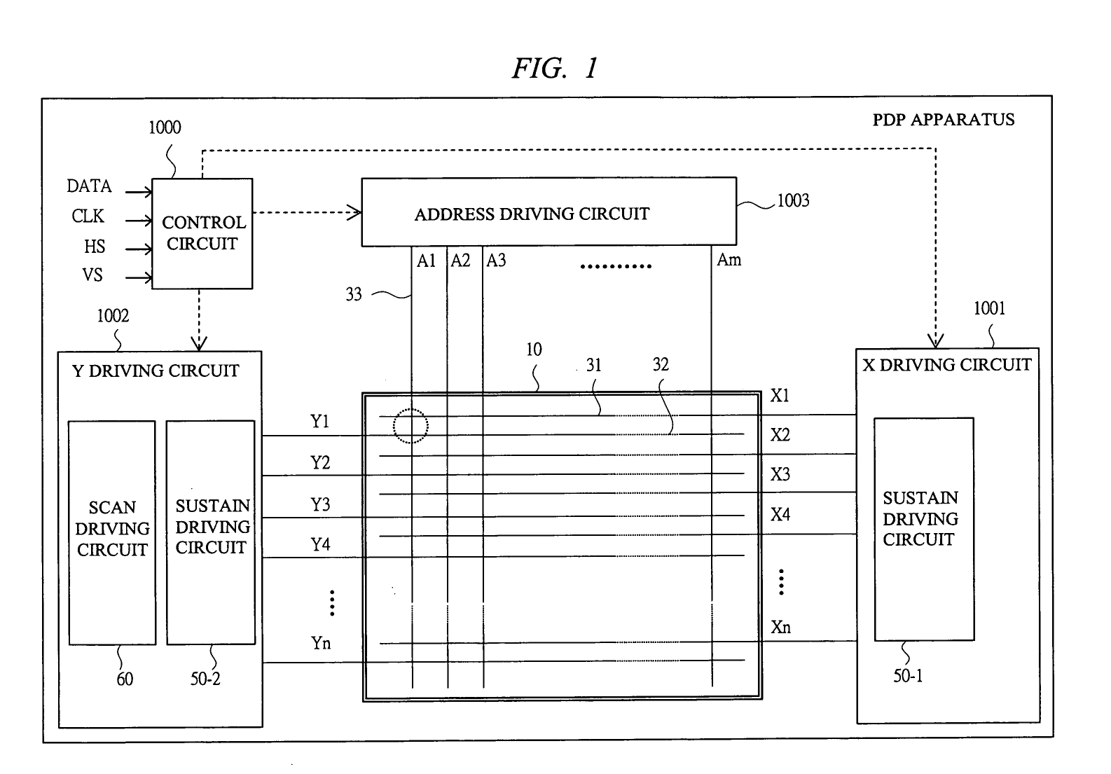

The first embodiment of the present invention will be described with reference to FIG. 1 to FIG. 3 and others. In the first embodiment, one coil (L0) is provided as a coil (L) for energy recovery of a sustain driving circuit. First, the basic structure of the PDP apparatus and the PDP common in the embodiments will be described.

<PDP Apparatus>

The entire structure of the PDP apparatus will be described with reference to FIG. 1. The PDP apparatus includes a PDP (panel) 10, a control circuit 1000, an X driving circuit 1001, a Y driving circuit 1002, and an address driving circuit 1003. The control circuit 1000 has a frame memory, a signal processing circuit and others. An image signal (DATA), a control clock (CLK), a horizontal synchronizing signal (HS), a vertical synchronizing signal (VS) and others are inputted to the control circuit 1000 to perform the process for the PDP driving control, and driving signals are outputted to each of the driving circuits and others. The X driving circuit 1001 has a sustain driving circuit 50-1. The Y driving circuit 1002 has a sustain driving circuit 50-2 and a scan driving circuit 60.

The PDP 10 is, for example, a three-electrode AC-driven panel having X electrodes 31, Y electrode 32, and address (A) electrodes 33, in which a display area composed of the matrix of the display cells corresponding to pixels is formed. The display lines are formed so as to correspond to the pairs of the display electrodes (31 and 32), and display columns and cells are formed so as to correspond to the intersections with the address electrodes 33. The display area of the PDP 10 is formed from the cell matrix and is correlated with a field and a sub-field to be the units of display.

Each of the driving circuits (1001, 1002, and 1003) drives the corresponding electrodes (31, 32, and 33) of the PDP 10 by applying the voltage waveforms. In particular, sustain discharge pulses are applied from the sustain driving circuits 50-1 and 50-2 to the display electrodes (X electrode 31 and Y electrode 32). In this manner, sustain discharges are generated in the display cells (capacitor (C)).

<PDP>

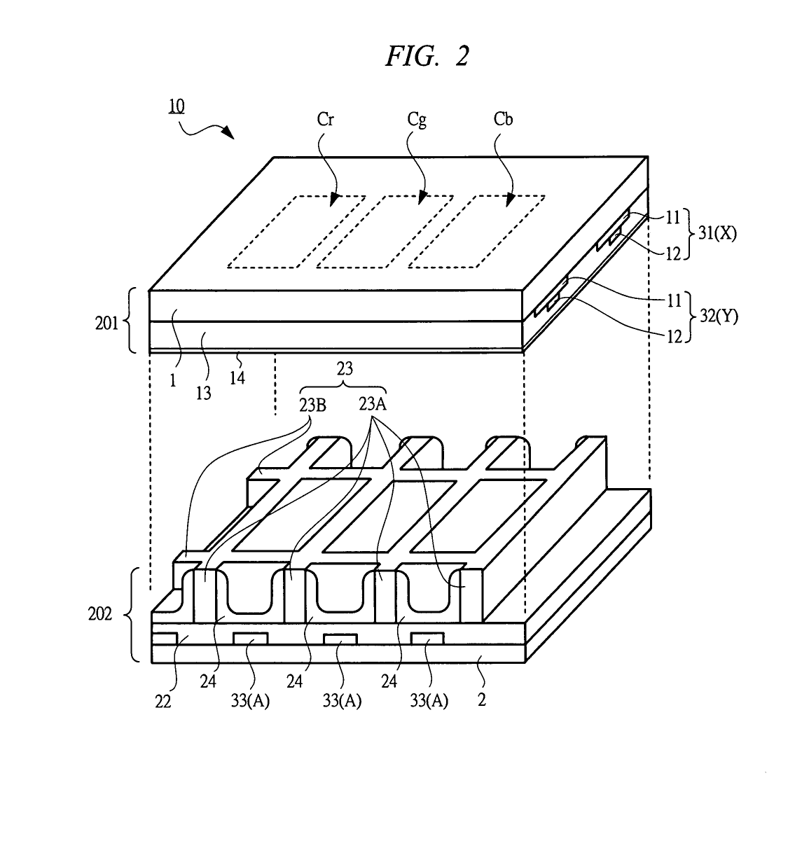

An example of the structure of the PDP 10 (case of three-electrode type and box rib) will be described with reference to FIG. 2. FIG. 2 shows a part corresponding to a pixel (set of cells of each color (Cr, Cg, Cb)) in the PDP 10. The PDP 10 is formed by combining structural bodies of a front substrate 1 and a rear substrate 2 mainly made of glass (front unit 201 and rear unit 202) opposed to each other, sealing the peripheral parts thereof, and filling the discharge gas in the spaces therebetween.

A plurality of X electrodes 31 and a plurality of Y electrodes 32 to be the display electrodes extend in parallel in a first direction and are alternately formed in a second direction on the front substrate 1. These display electrodes are covered with a dielectric layer 13 and a protective layer 14. A plurality of address electrodes 33 are formed on the rear substrate 2 so as to extend in parallel in the second direction, and they are covered with a dielectric layer 22. On the dielectric layer 22, barrier ribs 23A extending in the second direction are formed on both sides of the address electrodes 33, and the barrier ribs 23A partition the columns. Further, barrier ribs 23B extending in the first direction along the display electrodes are also formed, and the barrier ribs 23B partition the rows. The barrier ribs 23A and the barrier ribs 23B form the box-shaped barrier ribs 23. Further, phosphors 24 which are excited by the ultraviolet radiation and generate visible lights of each colors of red (R), green (G) and blue (B) are coated on the dielectric layer 22 and between the barrier ribs 23.

<Field>

An image frame displayed on the PDP 10 is correlated with a field to be the unit of control. One field is displayed with a display cycle of, for example, 1/60 second. The field is composed of a plurality of sub-fields obtained by temporally dividing a field for the grayscale display. Each of the sub-fields includes a sustain period in which the sustain discharge is generated, an address period, a reset period and others. A weight of luminance depending on the length of the sustain period is assigned to each of the sub-fields constituting the field. The grayscale is expressed by the selection and the combination of ON (lighting)/OFF (non-lighting) of the sub-fields in each cell of the field.

In the address period, the address operation of selecting the portions of ON/OFF of the cells in the sub-fields. More specifically, in the address operation, for the display lines to be driven, scan pulses are applied to the Y electrodes 32 and address pulses are applied to the address electrodes 33 so as to correspond to the selected cells, thereby generating the address discharges. In the subsequent sustain period, sustain discharge pulses are applied to the display electrodes (31 and 32), thereby generating the sustain discharges in the cells selected in the preceding address period to emit light for display.

Also, the structure of the PDP apparatus and the PDP 10 (normal structure) described above is merely an example, and there are various types of detailed structures depending on the driving method and others. For example, the technology according to embodiments of the present invention can be applied to the PDP apparatus and PDP with the so-called ALIS structure (structure in which display lines are formed of all pairs of the adjacent display electrodes) in the same manner.

### FIRST STRUCTURE EXAMPLE

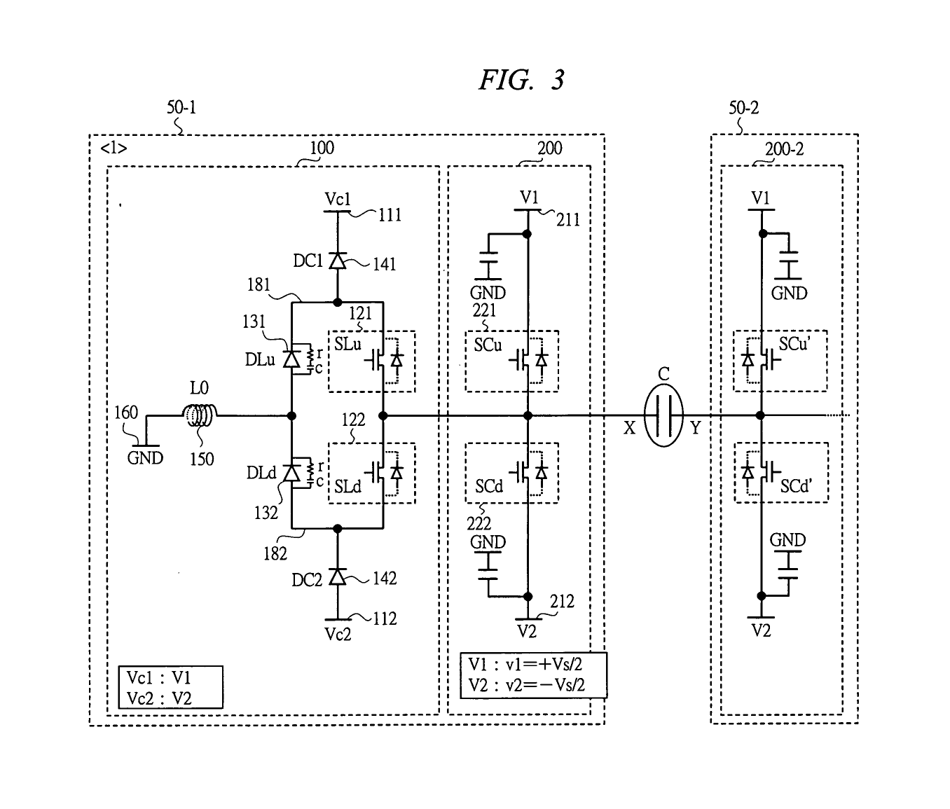

Next, the structure of the driving circuit (first structure example of all embodiments) according to the first embodiment will be described with reference to FIG. 3 and others. In FIG. 3, the sustain driving circuit 50-1 has the energy recovery circuit 100 and the Vs clamp circuit 200, and it is connected to the X electrode 31 of the panel capacitor (C). Also, the sustain driving circuit 50-2 having the Vs clamp circuit 200-2 with the similar structure is connected to the Y electrode 32 of the panel capacitor (C). The sustain driving circuit is connected to each capacitor (C) corresponding to the display cell of the PDP 10.

In the Vs clamp circuit 200, a first power source (V1) 211 on a high-potential (v1) side and a second power source (V2) 212 on a low-potential (v2) side corresponding to the sustain discharge voltage (Vs) are connected, and as a switch (SC) for controlling the Vs clamp operation, a first switch (SCu) 221 and a second switch (SCd) 222 are provided. The first switch (SCu) 221 is used for the Vs-clamp-up operation control, and the second switch (SCd) 222 is used for the Vs-clamp-down operation control.

Each of the switches (SC, SL) includes a switch element such as FET, and ON/OFF states thereof are controlled by the control inputs.

In the energy recovery circuit 100, a single coil (L0) 150 is provided as the coil (L) for energy recovery. The coil (L0) 150 is used for both the charging (charge supplying) operation to the capacitor (C) and the discharging (charge recovery) operation from the capacitor (C).

Further, the energy recovery circuit 100 has a first switch (SLu) 121 and a second switch (SLd) 122 as the switch (SL) for controlling the LC resonance operation. The first switch (SLu) 121 is used for controlling the LC-resonance-up operation, and the second switch (SLd) 122 is used for controlling the LC-resonance-down operation.

Further, the energy recovery circuit 100 has a first diode (DLu) 131 and a second diode (DLd) 132 as the diode (DL) for rectification of the LC resonance operation. The first diode (DLu) 131 provides the rectification in an LC-resonance-up direction so as to correspond to the first switch (SLu) 121, and the second diode (DLd) 132 provides the rectification in an LC-resonance-down direction so as to correspond to the second switch (SLd) 122.

The coil (L0) 150 is connected to a power source line 160 (GND) side having the almost intermediate potential of the sustain discharge voltage (Vs) and apart from the panel electrode (capacitor (C)). On the other hand, with regard to the switch (SL), the first switch (SLu) 121 and the second switch (SLd) 122 are connected to a side close to the panel electrode (capacitor (C)). This arrangement is different from that of the conventional structure shown in FIG. 13.

This structure example relates to the structure of power source voltage, and the voltage of the first power source (V1) 211 corresponding to the high potential (v1) of the sustain discharge pulse in the Vs clamp circuit 200 is +Vs/2 and the voltage of the second power source (V2) 212 corresponding to the low potential (v2) of the sustain discharge pulse is −Vs/2.

In the energy recovery circuit 100, a line having a diode for clamp (clamp diode) (DC) and a power source (Vc) connected thereto in the energy recovery circuit 100 is connected to a node between one end of the coil (L0) 150 (the other end thereof is connected to the power source line 160) and the switch (SL). In this example, the line is connected between the diode (DL) for controlling the LC resonance operation and the switch (SL). More specifically, the line on the high-potential side has the first clamp diode (DC1) 141, and the first power source (Vc1) 111 is connected thereto. Further, the line on the low-potential side has the second clamp diode (DC2) 142, and the second power source (Vc2) 112 is connected thereto.

The same structure as that for the voltage of the power sources (V1, V2) of the Vs clamp circuit 200 is used as the structure for the voltage of the power source (Vc) of the energy recovery circuit 100. More specifically, the voltage of the first power source (Vc1) 111 connected to the first diode (DC1) 141 on the high-potential side is equal to that of the first power source (V1) 211 of the Vs clamp circuit 200, that is, v1=+Vs/2, and the voltage of the second power source (Vc2) 112 connected to the second diode (DC2) 142 on the low-potential side is equal to that of the second power source (V2) 212 of the Vs clamp circuit 200, that is, v2=−Vs/2.

The charge of the panel capacitor (C) is recovered to the power source (for example, the condenser for the power source V2 (−Vs/2) on the low-potential side) via the GND (power source line 160) connected to the coil (L0) 150 of the energy recovery circuit 100. Conversely, the charge is supplied to the panel capacitor (C) from the power source (for example, condenser for the power source V2) via the GND (power source line 160) connected to the coil (L0) 150 of the energy recovery circuit 100.

Further, an RC circuit (resistor r and condenser c) is connected in parallel to each clamp diode (DC1, DC2) of the energy recovery circuit 100 in this structure. The RC circuit is provided in order to reduce the abrupt voltage, and the structure having the RC circuit is more desirable for the operation stability.

Note that, although the energy recovery circuit 100 is provided only on one side of the panel electrodes (X, Y) (in this example, on the X electrode 31 side), it can be provided on both sides thereof (the same is true of the embodiments described later).

### Second Embodiment

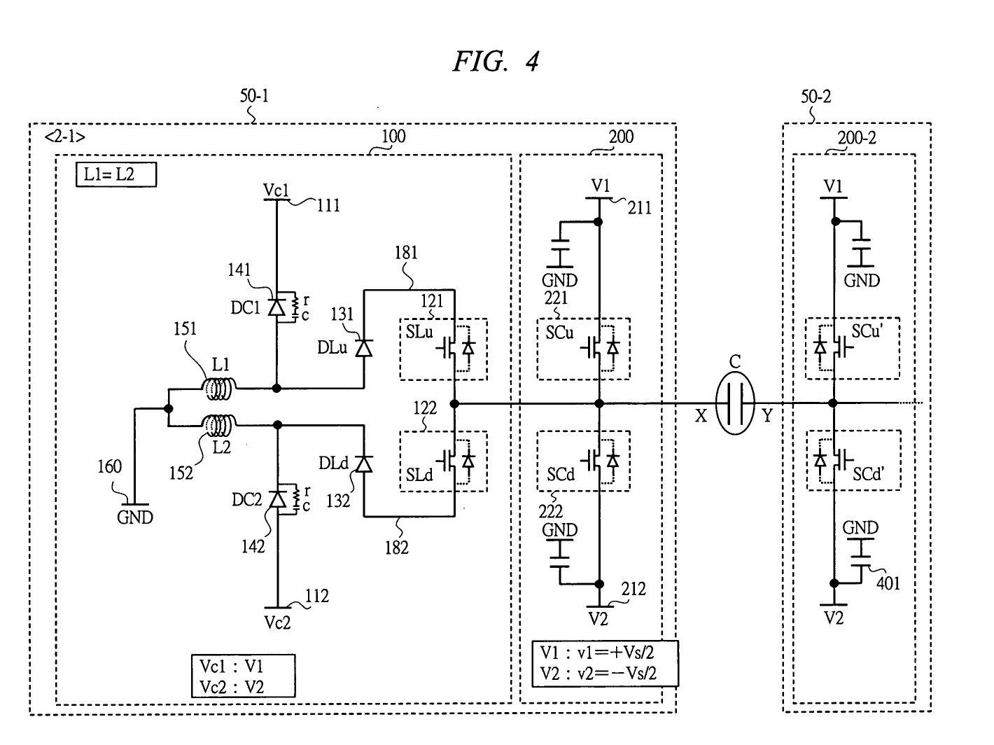

Next, the second embodiment of the present invention will be described with reference to FIG. 4 to FIG. 6 and others. In the second embodiment, two coils are independently provided as the coil (L) for energy recovery.

### SECOND STRUCTURE EXAMPLE (2-1)

FIG. 4 shows the structure of the driving circuit according to the second embodiment (second structure example). In the sustain driving circuit 50-1, the Vs clamp circuit 200 has the same structure as described above.

In the energy recovery circuit 100, two independent coils, that is, a first coil (L1) 151 and a second coil (L2) 152 are provided as the coil (L) for energy recovery. The first coil (L1) 151 is used for the charging (charge supplying) operation to the capacitor (C), and the second coil (L2) 152 is used for the discharging (charge recovery) operation from the capacitor (C). In this example, these coils (L1, L2) have a relation in inductance (denoted by the same symbol) of L1≈L2.

Also, similar to that described above, the energy recovery circuit 100 has a first switch (SLu) 121 and a second switch (SLd) 122 as the switch for controlling the LC resonance operation (SL), and it also has a first diode (DLu) 131 and a second diode (DLd) 132 as the diode (DL) corresponding thereto.

Each of the coils (L1, L2) is connected to the power source line 160 (GND) having the almost intermediate potential of the sustain discharge voltage (Vs). Meanwhile, the first switch (SLu) 121 and the second switch (SLd) 122 for controlling the LC resonance are connected to the side close to the panel electrode (capacitor (C)).

This structure example relates to the structure of power source voltage, and the voltage of the first power source (V1) 211 corresponding to the high potential (v1) of the sustain discharge pulse is +Vs/2, and the voltage of the second power source (V2) 212 corresponding to the low potential (v2) of the sustain discharge pulse is −Vs/2. The same structure as that for the voltage of the power sources (V1, V2) of the Vs clamp circuit 200 is used as the structure for the voltage of the power source (Vc) of the energy recovery circuit 100.

In the energy recovery circuit 100, a line having a clamp diode (DC) and a power source (Vc) connected thereto in the energy recovery circuit 100 is connected to a node between one end of each coil (L1, L2) and the switch (SL). In this example, the line is connected between the coil (L1, L2) and the diode (DL). More specifically, the line on the high-potential side has the first clamp diode (DC1) 141, and the first power source (Vc) 111 is connected thereto. Further, the line on the low-potential side has the second clamp diode (DC2) 142, and the second power source (Vc2) 112 is connected thereto. Also, an RC circuit is connected in parallel to each clamp diode (DC1 and DC2) of the energy recovery circuit 100.

The charge of the panel capacitor (C) is recovered to the power source (for example, the condenser (401) for the power source V2 (−Vs/2) on the low-potential side) via the GND (power source line 160) connected to the second coil (L2) 152 of the energy recovery circuit 100. Conversely, the charge is supplied to the panel capacitor (C) from the power source (for example, condenser (401) for the power source V2) via the GND (power source line 160) connected to the first coil (L1) 151 of the energy recovery circuit 100.

### THIRD STRUCTURE EXAMPLE (2-2)

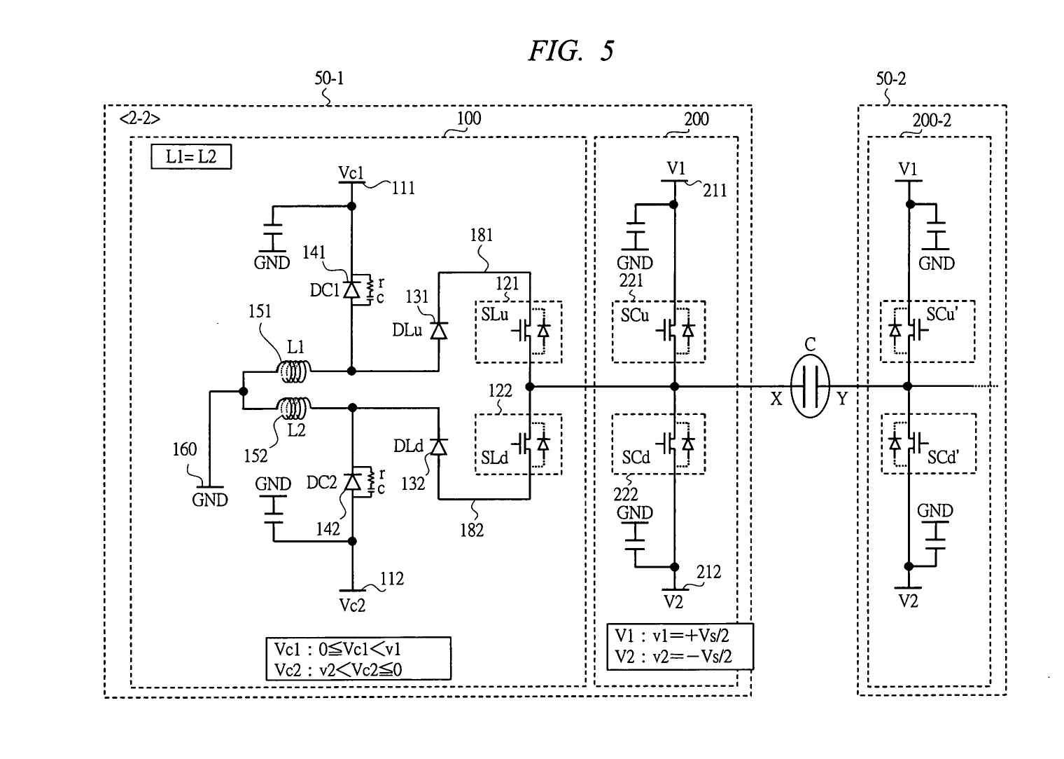

FIG. 5 shows another structure (third structure example) of the sustain driving circuit 50-1 according to the second embodiment. In this structure of the power source (Vc) of the energy recovery circuit 100, the voltage values of the power sources Vc (Vc1, Vc2) are set to be lower than the voltage absolute values of the power sources (V1, V2) of the Vs clamp circuit 200. More specifically, in the first power source (Vc1) 111 connected to the first diode (DC1) on the high-potential side, the voltage value thereof is set to a value within a range lower than the voltage of the first power source (V1) 211 on the high-potential (v1) side of the Vs clamp circuit 200 and equal to or higher than the intermediate potential of Vs ((v1+v2)/2) so as to satisfy the conditions defined by the following expressions (1) and (2).

{(v1+v2)/2}≦Vc1<v1 (1)

0≦Vc1<(+Vs/2) (2)

Similarly, in the second power source (Vc2) connected to the second diode (DC2) on the low-potential side, the voltage value is set in the same manner so as to satisfy the conditions of the following expressions (3) and (4).

v2<Vc2≦{(v1+v2)/2} (3)

(−Vs/2)<Vc2≦0 (4)

<Control Timing (1)>

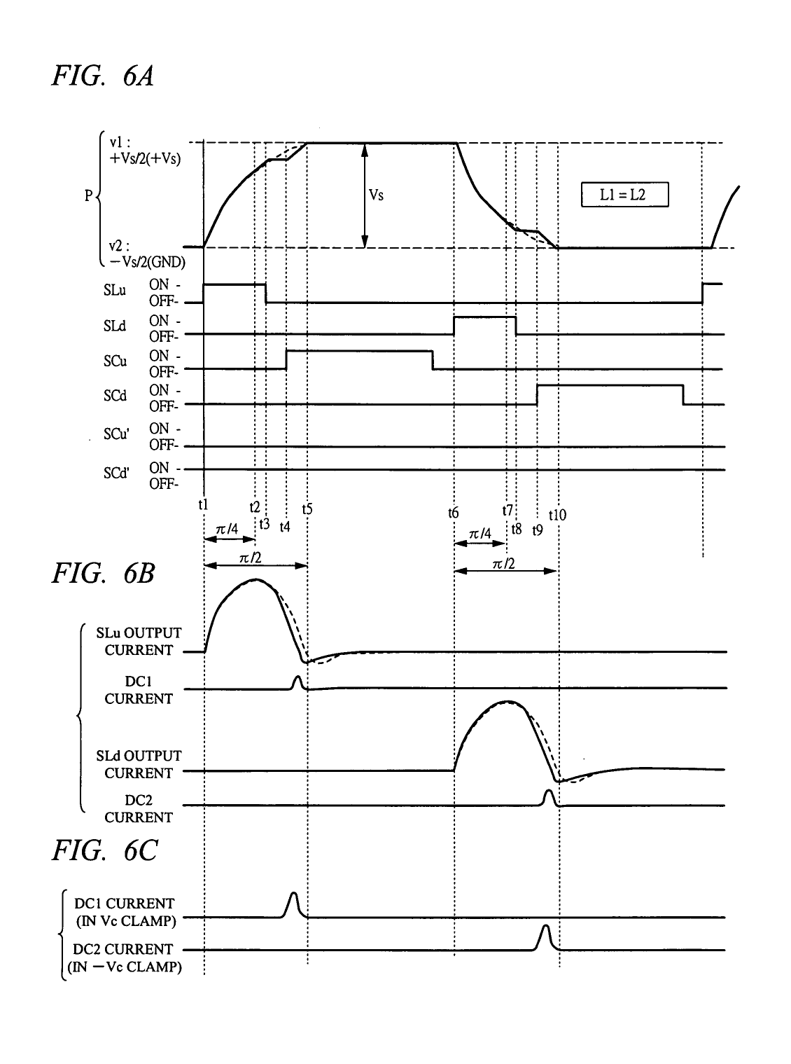

Next, the control operation timing, the output voltage and others in the structure of the sustain driving circuit 50-1 according to the second embodiment will be described with reference to FIG. 6. FIG. 6 shows the control timing of the sustain discharge pulses, the circuit output voltage, and the circuit current waveform in the typical structure.

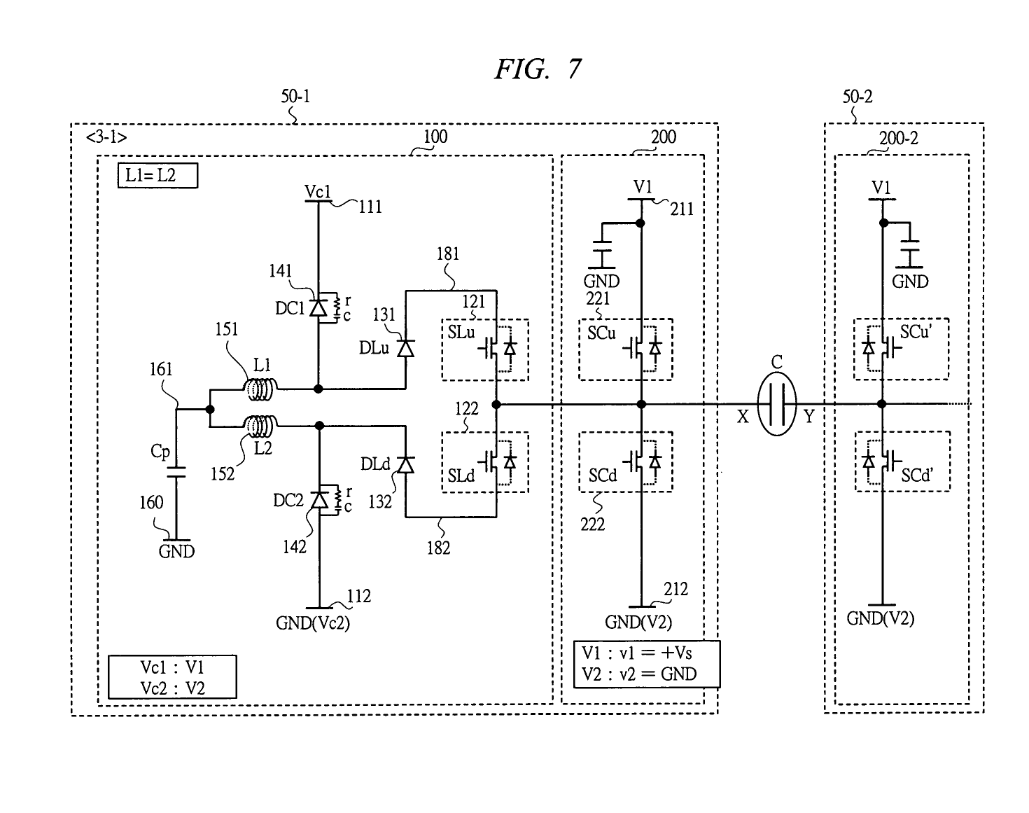

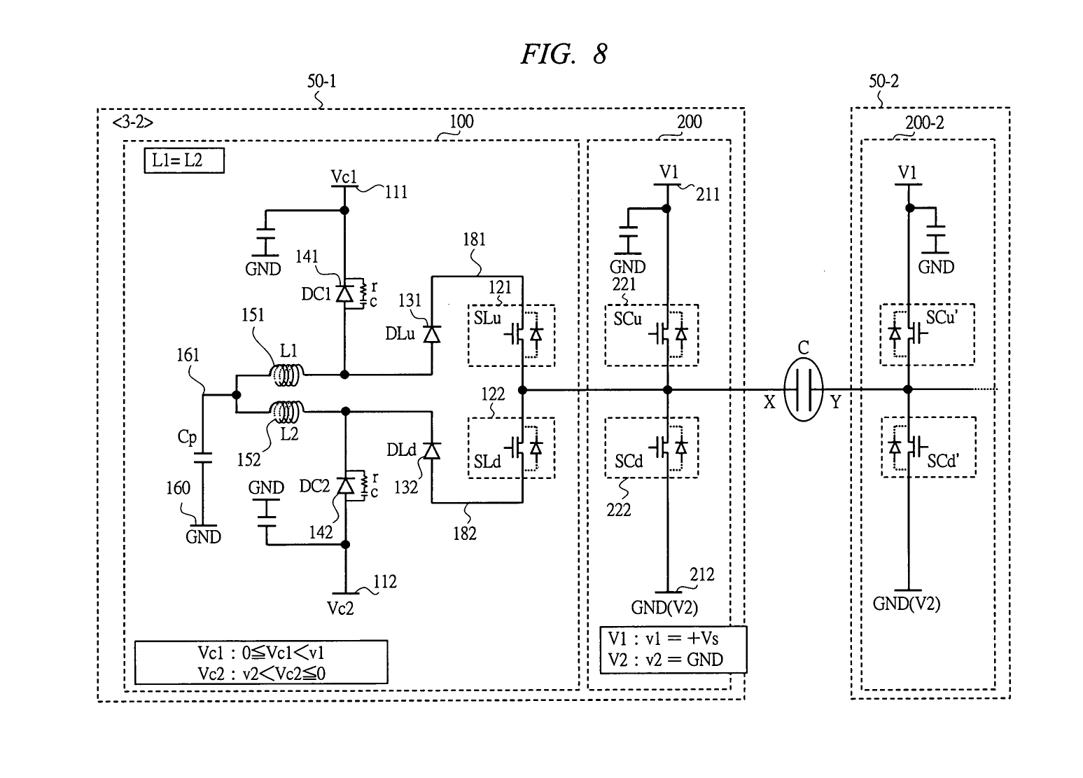

FIG. 6A shows waveforms in the second structure example according to the second embodiment shown in FIG. 4 (the same is true of the case of the fourth structure example according to the third embodiment shown in FIG. 7 described later). The case where the coils have a relation in inductance of L1≈L2 is shown here. FIG. 6B shows the waveforms of the output currents of the switch (SL) and the currents of the clamp diode (DC) in the case of FIG. 6A. FIG. 6C shows the current waveforms of the clamp diode (DC) in the third structure example according to the second embodiment shown in FIG. 5 (the same is true of the case of the fifth structure example according to the third embodiment shown in FIG. 8 described later). The waveform drawn by a solid line represents the case of the early clamp control in this embodiment, and the waveform drawn by a dotted line overlapped thereon represents the case of the conventional control other than the early clamp control. In the case of the conventional control, the timing of the Vs clamp is slower than the timing (t4) of the present embodiment, or the switch of the Vs clamp is not turned ON in the course of the LC resonance operation.

First, the control timing of each of the switches will be described with reference to FIG. 6A. P represents the sustain discharge pulse applied from the sustain driving circuit 50-1 to the panel electrode (capacitor (C)). v1 and v2 are ±Vs/2 (in the case of the second structure example) or Vs and GND as shown in the parentheses (in the case of the fourth structure example). SLu to SCd′ represent the waveforms of ON/OFF by the control inputs corresponding to the above-described switches. t1 and the like represent timings. Further, π represents the LC resonance current cycle. With regard to the direction of the current of the switch, the direction of the supply to the panel is positive in SLu, and the direction of the recovery from the panel is positive in SLd. Further, with regard to the direction of the current of the clamp diode (DC), the direction from an anode to a cathode is positive.

The control operation in the charge supply (charging) from the energy recovery circuit 100 to the panel capacitor (C) is as follows. First, the switch (SLu) 121 is turned ON (t1), and current flows from the GND (power source line 160) via the first coil (L1) 151 and the LC resonance operation is started in the first coil (L1) 151 of the energy recovery circuit 100 and the panel capacitor (C). By this LC resonance, the rising waveform becomes a curved line whose slope is gently changed temporally as shown by t1 to t3.

Next, after t1, as the timing condition of the early clamp control, at the timing of more than π/4 (t2) and less than π/2 (t5) of the LC resonance current cycle (π), the switch (SLu) 121 is first turned OFF (t3) and then the switch (SCu) 221 is turned ON (t4). By this means, the potential of the panel electrode is clamped to the high-potential (v1) side of the sustain discharge voltage (Vs) (t5). By turning ON the switch (SCu) 221, the capacitor (C) is directly coupled to the first power source (V1) 211. Therefore, the voltage immediately rises to Vs as shown by the period from t4 to t5, and the gas discharge is generated at the firing voltage (Vi). In other words, the above-described timing condition of the early clamp control is before supplying all the charge accumulated in the coil (L) to the panel capacitor (C). A part of the charge remaining in the coil (L) is recovered to the power source via the clamp diode (DC).

Next, the control operation in the charge recovery (discharge) from the panel capacitor (C) to the energy recovery circuit 100 is as follows. First, the switch (SLd) 122 is turned ON (t6), and the LC resonance operation is started in the second coil (L2) 152 of the energy recovery circuit 100 and the panel capacitor (C). Then, at the timing of more than π/4 (t7) and less than π/2 (t10) of the LC resonance current cycle (π), the switch (SLd) 122 is first turned OFF (t8) and then the switch (SCd) 222 is turned ON (t9). By this means, the potential of the panel electrode is clamped to the low-potential (v2) side of Vs (t10). In other words, the above-described timing condition of the early clamp control is before recovering all the charge accumulated in the coil (L) from the capacitor (C) to the power source (condenser). A part of the charge remaining in the coil (L) is recovered to the power source via the clamp diode (DC).

In the above-described operation, the first coil (L1) 151 (or second coil (L2) 152) of the energy recovery circuit 100 is electrically isolated from the panel electrode (capacitor (C)) because the switch (SLu) 121 (or switch (SLd) 122) is turned OFF, and it is not subject to the influence at the Vs clamp by the operation of the switch (SCu) 221 (or switch (SCd) 222) and the influence at the gas discharge (voltage variation in the panel electrode due to large current and others).

By the control operation in FIG. 6A, the currents of the switch (SLu, SLd) and the clamp diode (DC1, DC2) in the energy recovery circuit 100 are changed as shown in FIG. 6B. SLu output current represents the current at the LC-resonance-up operation, and DC1 current represents the current to be recovered. Similarly, SLd output current represents the current at the LC-resonance-down operation, and DC2 current represents the current to be recovered.

In FIG. 6C, as shown by DC1 current, in the third structure example of FIG. 5, that is, in the structure in which the voltage of the first power source (Vc1) 111 connected to the first diode (DC1) 141 on the charge supplying side is set to be lower than the high-potential (v1) side of Vs, the charge remaining in the first coil (L1) by turning OFF the switch (SLu) 121 at the time of supplying the charge to the panel can be recovered to the power source (Vc1) more than the case of the second structure example shown in FIG. 4. As described below, the address power source (Va) can be used for the voltage of the first power supply (Vc1).

Similarly, as shown by DC2 current, in the structure in which the voltage of the second power source (Vc2) 112 connected to the second diode (DC2) 142 on the charge recovery side is set to be higher than the low-potential (v2) side of Vs, the charge remaining in the second coil (L2) by turning OFF the switch (SLd) 122 at the time of charge recovery from the panel can be more recovered to the power source.

### MODIFIED EXAMPLE (1)

As a modified example relating to the structure of the sustain driving circuit 50-1, the power source (address power source (Va)) used for the pulse for address selection discharge (address pulse) in the address driving circuit 1003 can be used as the power source (Vc1, Vc2) connected to the energy recovery circuit 100, that is, it can be used for both of them. In this structure, the structure for the voltage of the address power source (Va) satisfies the conditions of the above-described expressions. This structure can be similarly applied to the structure examples in the embodiments.

### Third Embodiment

Next, the third embodiment of the present invention will be described with reference to FIG. 7 and FIG. 8 and others. In the third embodiment, as the structure for the voltage of the power source relating to the Vs clamp circuit 200, V1 and V2 are Vs and GND instead of ±Vs/2.

### FOURTH STRUCTURE EXAMPLE (3-1)

FIG. 7 shows the structure (fourth structure example) of the sustain driving circuit 50-1 according to the third embodiment. In this sustain driving circuit 50-1, as the voltage of the power source (V1, V2) of the Vs clamp circuit 200, the first power source (V1) 211 corresponding to the high potential (v1) of the sustain discharge pulse is set to have v1=+Vs, and the second power source (V2) 212 corresponding to the low potential (v2) of the sustain discharge pulse is set to have v2=0 (GND). The condenser for energy recovery (Cp) is connected to a power source line 160 on the low-potential side. A node 161 on the power source line 160 is set to almost intermediate potential of Vs (+Vs2) by some operations.

Further, the power source (Vc) connected to the clamp diode (DC) of the energy recovery circuit 100 has the same voltage structure as that of the power sources (V1, V2) of the Vs clamp circuit 200. More specifically, the first power source (Vc1) 111 connected to the first diode (DC1) on the high-potential side is set to have v1 (+Vs), and the second power source (Vc2) 112 connected to the second diode (DC2) on the low-potential side is set to have 0 (GND).

The charge of the panel capacitor (C) is recovered to the condenser (Cp) connected to the other end (node 161) of the coil (L1, L2) of the energy recovery circuit 100. Further, the charge is supplied to the panel capacitor (C) from the condenser (Cp) connected to the other end (node 161) of the coil (L1, L2) of the energy recovery circuit 100.

### FIFTH STRUCTURE EXAMPLE (3-2)

FIG. 8 shows another structure (fifth structure example) of the sustain driving circuit 50-1 according to the third embodiment. In this sustain driving circuit 50-1, as the voltage of the power source (V1, V2) of the Vs clamp circuit 200, similar to that described above, the first power source (V1) 211 is set to have v1=+Vs, and the second power source (V2) 212 is set to have v2=0 (GND). On the other hand, as the voltage of the power source (Vc) of the energy recovery circuit 100, the voltage values of the power sources (Vc) are set to be lower than the voltage absolute values of the power sources (V1, V2) of the Vs clamp circuit 200. More specifically, from the same conditions defined by the expressions (1) and (3) above, in the first power source (Vc1) 111 connected to the first diode (DC1) on the high-potential side, the voltage value thereof satisfies the following expression (5) (lower than v1 and equal to or higher than Vs intermediate potential), and in the second power source (Vc2) 112 connected to the second diode (DC2) on the low-potential side, the voltage value thereof satisfies the following expression (6) (higher than v2 and equal to or lower than Vs intermediate potential).

(+Vs/2)≦Vc1<(+Vs) (5)

0<Vc2≦(+Vs/2) (6)

### Fourth Embodiment

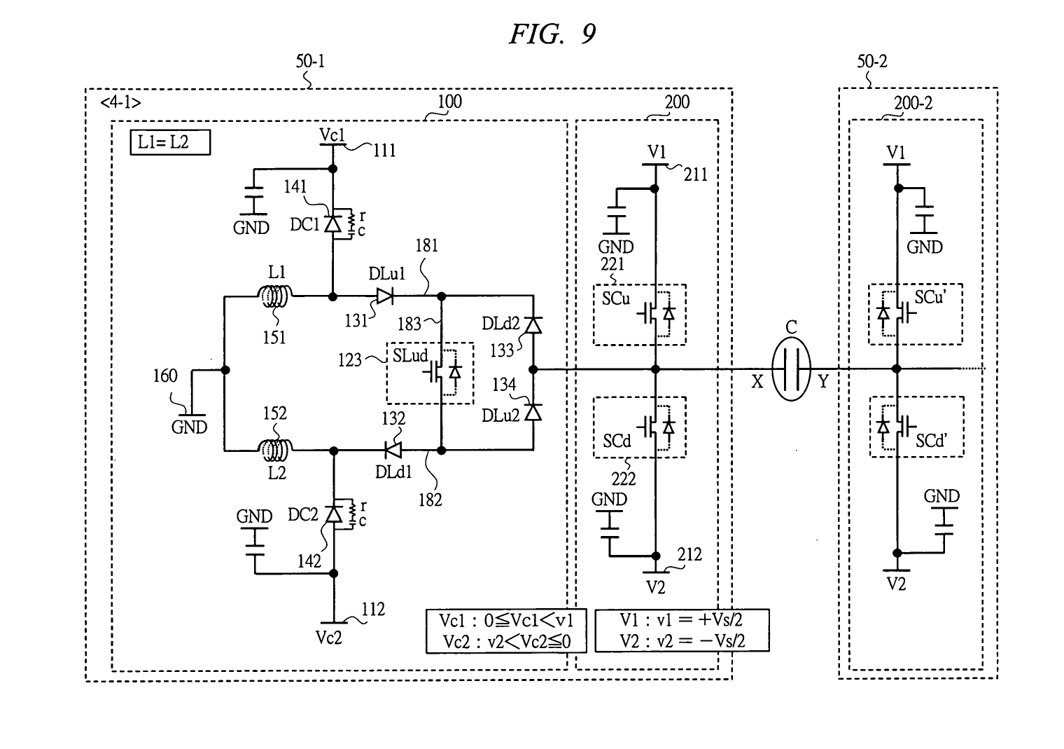

Next, the fourth embodiment of the present invention will be described with reference to FIG. 9 to FIG. 11 and others. In the structure of the fourth embodiment, the switch (SL) for controlling the LC resonance is combined into the single switch.

### SIXTH STRUCTURE EXAMPLE (4-1)

FIG. 9 shows the structure (sixth structure example) of the sustain driving circuit 50-1 according to the fourth embodiment. In this energy recovery circuit 100, the first switch (SLu) 121 for charge supply and the second switch (SLd) 122 for charge recovery in the above-described switch (SL) are combined into a common switch (SLud) 123. By this means, the number of components is reduced. A diode (DLu2) 134 and a diode (Dud2) 133 are also provided for the single switch (SLud) 123. The switch (SLud) 123 is provided on a line (183) which connects the two lines for charge and discharge (181 and 182), and diodes (DLu1, DLd1, DLu2, DLd2) are provided on the lines (181, 182) in front and at the back of the switch (SLud) 123.

The structure of the power source (V1, V2) of the Vs clamp circuit 200 is the same as that described above, (that is, v1=+Vs/2, v2=−Vs/2). In the structure of the power source (Vc) of the energy recovery circuit 100, for example, the voltage values thereof are set to be lower than those of the power sources (V1, V2) of the Vs clamp circuit 200. The inductance of the coil is L1≈L2.

### SEVENTH STRUCTURE EXAMPLE (4-2)

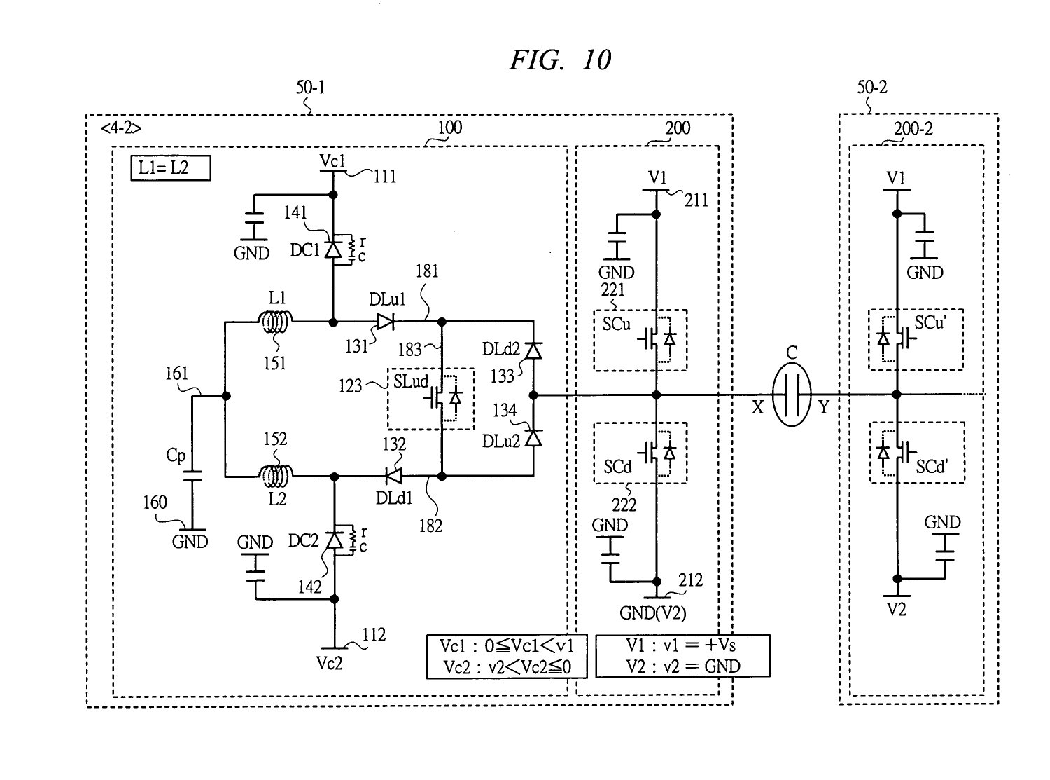

FIG. 10 shows another structure (seventh structure example) of the sustain driving circuit 50-1 according to the fourth embodiment. In this sustain driving circuit 50-1, as the voltage of the power source (V1, V2) of the Vs clamp circuit 200, similar to that described above, the power source (V1) 211 is set to have v1=+Vs, and the power source (V2) 212 is set to have v2=0 (GND). As the voltage of the power source (Vc) of the energy recovery circuit 100, the voltage values of the power sources (Vc) are set to be lower than the voltage absolute values of the power sources (V1, V2) of the Vs clamp circuit 200. Further, in this energy recovery circuit 100, the first switch (SLu) 121 for charge supply and the second switch (SLd) 122 for charge recovery are combined into a common switch (SLud) 123.

<Control Timing (2)>

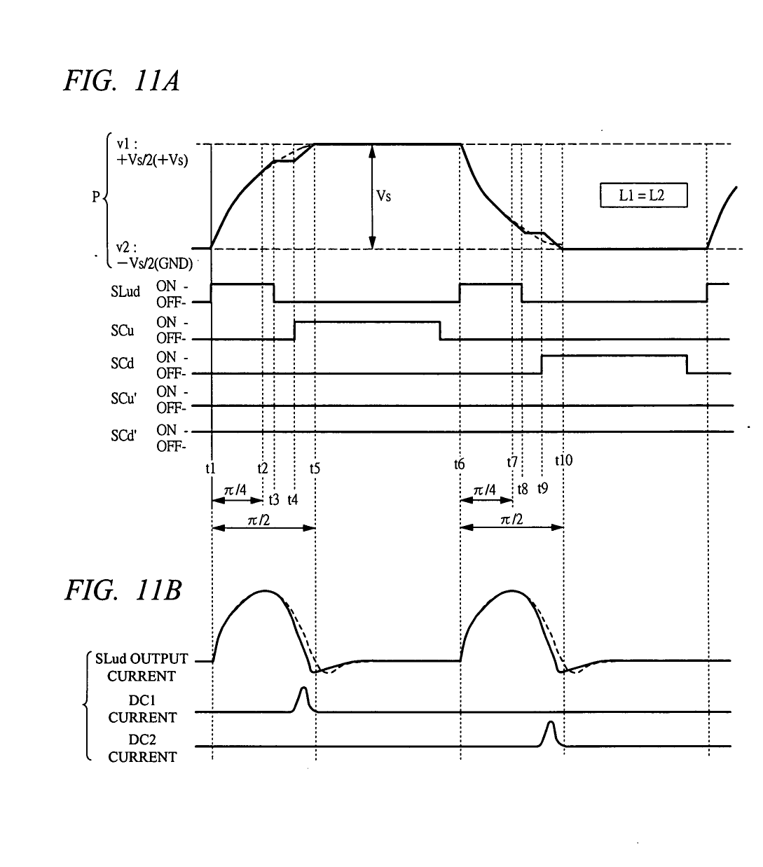

FIG. 11A and FIG. 11B show the waveforms for the control operation timing in the case of the sixth structure example according to the fourth embodiment shown in FIG. 9 (the same is true of the case of the seventh structure example shown in FIG. 10) in the same format as that of FIG. 6. In the structure of FIG. 11, different from that of FIG. 6, the control operation corresponds to the structure in which the first switch (SLu) 121 for charge supply and the second switch (SLd) 122 for charge recovery in the energy recovery circuit 100 are combined into the common switch (SLud) 123. More specifically, as shown by SLud, the switch (SLud) 123 is turned ON in each of the periods t1 to t3 and t6 to t8 so as to correspond to both the LC-resonance-up operation and the LC-resonance-down operation. The output current of the switch (SLud) 123 is as shown in FIG. 11B.

### MODIFIED EXAMPLE (2)

As the modified example of the above-described embodiments (second to fifth embodiments), the structure in which the inductances of the two coils (L1 and L2) in the same circuit structure as described above have the relation of L1<L2 will be described. In this structure, the time for the discharge from the panel capacitor (C) is longer than that for the charging to the panel capacitor (C).

<Control Timing (3)>

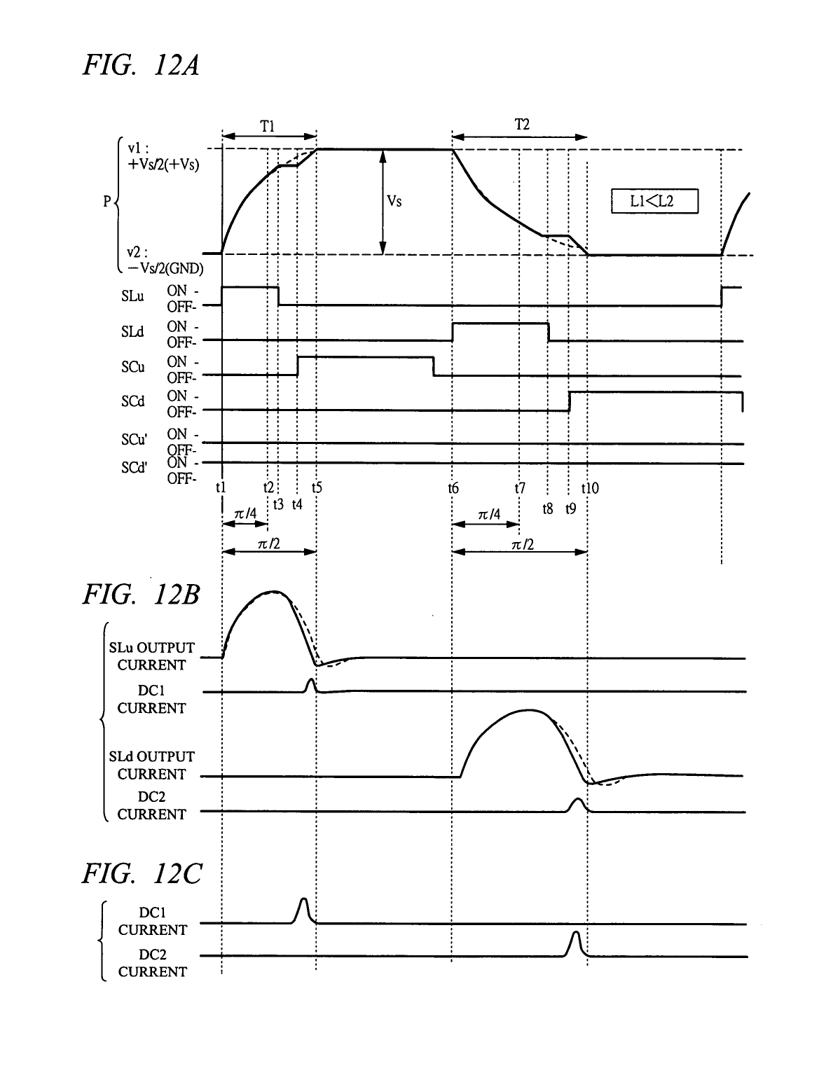

FIG. 12A shows the waveforms for the control timing in the case where the inductances of the coils are set to have the relation of L1<L2 in the second structure example according to the second embodiment shown in FIG. 4 (or fourth structure example according to the third embodiment shown in FIG. 7). FIG. 12B shows the output currents of the switch (SL) and the current waveforms of the clamp diode (DC) in the case of FIG. 12A. FIG. 12C shows the current waveforms of the clamp diode (DC) in the case where the inductances of the coils are set to have the relation of L1<L2 in the third structure example according to the second embodiment shown in FIG. 5 (or fifth structure example according to the third embodiment shown in FIG. 8).

The difference between these structures and the structure in the case of L1≈L2 shown in FIG. 6 is that the charge recovery time from the panel (shown by T2 (t6 to t10)) is longer than the charge supply time to the panel (shown by T1 (t1 to t5)) because of L1<L2.

By the structures described above, the stability in the circuit operation better than that in the conventional technology can be achieved. In particular, when the sustain discharge pulse is to be applied to the panel electrode from the sustain driving circuit 50-1, the electrical conduction between the side of the coil (L) of the energy recovery circuit 100 and the side of the panel and the VS clamp circuit 200 can be controlled. Therefore, the stability of the circuit operation can be achieved. Furthermore, when the power source (Vc) connected to the clamp diode (DC) of the energy recovery circuit 100 is designed to have a voltage value lower than that of the power source (V1, V2) of the Vs clamp circuit 200, the more charge can be recovered. Therefore, the reduction in power consumption can be achieved.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention can be applied to PDP apparatus and others.

What is claimed is:

1. A driving circuit device of a plasma display panel which drives electrodes of an AC-driven plasma display panel by applying voltage waveforms, comprising:
a sustain discharge pulse driving circuit which includes an energy recovery circuit and a clamp circuit connected to the electrodes used for sustain discharge in the panel and applies sustain discharge pulses to the electrodes,
wherein, in the sustain discharge pulse driving circuit, the energy recovery circuit has a coil, first-type switches for controlling an LC resonance operation, and first-type diodes for rectification, and performs an operation of recovering an energy charged in a capacitor by LC resonance of an inductance of the coil and the capacitor between the electrodes of the panel,
the clamp circuit has second-type switches to which a first power source corresponding to high potential and a second power source corresponding to low potential as first-type power sources corresponding to a voltage of the sustain discharge pulse to be applied between the electrodes of the panel capacitor are connected, and which are used for controlling an operation of clamping to the high potential and the low potential, respectively,
in the energy recovery circuit, one end of the coil is connected to the electrodes of the panel via the first-type diodes and the first-type switches, and the other end of the coil is connected to a power source line having almost intermediate potential of the voltage of the sustain discharge pulse,
lines each having a second-type diode for clamp and a second-type power source connected thereto in the energy recovery circuit are connected to nodes between the one end of the coil and the first-type switches, and
as an operation control in applying the sustain discharge pulses, the LC resonance is generated by turning ON the first-type switch of the energy recovery circuit in a state where the second-type switch of the clamp circuit is turned OFF, and then, at a timing of π/4 or more and less than π/2 of an LC resonance current cycle, the first-type switch is turned OFF, and subsequently, the second-type switch is turned ON, thereby clamping to the high potential or the low potential of the sustain discharge pulse.

2. The driving circuit device of a plasma display panel according to claim 1,
wherein the energy recovery circuit has, as the second-type power sources, a first power source on a high-potential side with the same voltage as that of the first-type first power source and a second power source on a low-potential side with the same voltage as that of the first-type second power source.

3. The driving circuit device of a plasma display panel according to claim 1,
wherein the energy recovery circuit includes: as the coil, a first coil used when supplying current to the electrodes of the panel from the energy recovery circuit by the LC resonance operation and a second coil used when supplying current from the electrodes of the panel to the energy recovery circuit, on parallel lines; and
as the second-type power sources, a first power source on a high-potential side with a potential lower than the voltage of the first-type first power source and equal to or higher than the intermediate potential of the sustain discharge pulse and a second power source on a low-potential side with a potential higher than the voltage of the first-type second power source and equal to or lower than the intermediate potential of the sustain discharge pulse, and
as the second-type diodes, a first diode for clamping to the second-type first power source is connected to a node between the first coil and the first-type switch.

4. The driving circuit device of a plasma display panel according to claim 1,
wherein the energy recovery circuit includes: as the coil, a first coil used when supplying current to the electrodes of the panel from the energy recovery circuit by the LC resonance operation and a second coil used when supplying current from the electrodes of the panel to the energy recovery circuit, on parallel lines; and
as the second-type power sources, a first power source on a high-potential side with a potential lower than the voltage of the first-type first power source and equal to or higher than the intermediate potential of the sustain discharge pulse and a second power source on a low-potential side with a potential higher than the voltage of the first-type second power source and equal to or lower than the intermediate potential of the sustain discharge pulse, and
as the second-type diode, a second diode for clamping to the second-type second power source is connected to a node between the second coil and the first-type switch.

5. The driving circuit device of a plasma display panel according to claim 1,
wherein the energy recovery circuit includes: as the coil, a first coil used when supplying current to the electrodes of the panel from the energy recovery circuit by the LC resonance operation and a second coil used when supplying current from the electrodes of the panel to the energy recovery circuit, on parallel lines;
as the first-type switches, a first switch on a charging side to the capacitor and a second switch on a discharging side from the capacitor;
as the first-type diodes, a first diode on a charging side to the capacitor and a second diode on a discharging side from the capacitor; and
as the second-type power sources, a first power source on a high-potential side with a potential equal to or lower than the voltage of the first-type first power source and equal to or higher than the intermediate potential of the sustain discharge pulse and a second power source on a low-potential side with a potential equal to or higher than the voltage of the first-type second power source and equal to or lower than the intermediate potential of the sustain discharge pulse, and
as the second-type diodes, a first diode for clamping to the second-type first power source is connected to a node between the first coil and the first-type first switch and a second diode for clamping to the second-type second power source is connected to a node between the second coil and the first-type second switch.

6. The driving circuit device of a plasma display panel according to claim 3,
wherein the energy recovery circuit uses a power source voltage used for pulses for an address selection discharge to address electrodes of the panel in common as the second-type first power source.

7. The driving circuit device of a plasma display panel according to claim 4,
wherein the energy recovery circuit uses a power source voltage used for pulses for an address selection discharge to address electrodes of the panel in common as the second-type second power source.

8. The driving circuit device of a plasma display panel according to claim 2,
wherein inductance of the first coil is smaller than that of the second coil in the energy recovery circuit.

9. The driving circuit device of a plasma display panel according to claim 7,
wherein inductance of the first coil is smaller than that of the second coil in the energy recovery circuit.

10. The driving circuit device of a plasma display panel according to claim 2,
wherein the energy recovery circuit includes: as the first-type switch for controlling the LC resonance operation, one common switch for controlling both charging and discharging to and from the capacitor on a third line which connects the first line on a high-potential side and the second line on a low-potential side of the sustain discharge pulse; and
as the first-type diodes, first to fourth diodes for rectification of the charging and discharging on the first and second lines in front and at the back of the switch.

11. The driving circuit device of a plasma display panel according to claim 7,
wherein the energy recovery circuit includes: as the first-type switch for controlling the LC resonance operation, one common switch for controlling both charging and discharging to and from the capacitor on a third line which connects the first line on a high-potential side and the second line on a low-potential side of the sustain discharge pulse; and
as the first-type diodes, first to fourth diodes for rectification of the charging and discharging on the first and second lines in front and at the back of the switch.

12. A plasma display apparatus comprising:
an AC-driven plasma display panel having first and second electrodes used for sustain discharge and third electrodes used for address selection discharge; and
driving circuit devices for driving each of the electrodes of the panel,
wherein the driving circuit device for driving the first or second electrodes of the panel has a sustain discharge pulse driving circuit which includes an energy recovery circuit and a clamp circuit connected to the first or second electrodes and applies sustain discharge pulses to the electrodes,
in the sustain discharge pulse driving circuit, the energy recovery circuit has a coil, first-type switches for controlling an LC resonance operation, and first-type diodes for rectification, and performs an operation of recovering an energy charged in a capacitor by LC resonance of an inductance of the coil and the capacitor between the electrodes of the panel,
the clamp circuit has second-type switches to which a first power source corresponding to high potential and a second power source corresponding to low potential as first-type power sources corresponding to a voltage of the sustain discharge pulse to be applied between the electrodes of the panel are connected, and which are used for controlling an operation of clamping to the high potential and the low potential, respectively,
in the energy recovery circuit, one end of the coil is connected to the electrodes of the panel via the first-type diodes and the first-type switches, and the other end of the coil is connected to a power source line having almost intermediate potential of the voltage of the sustain discharge pulse, and lines each having a second-type diode for clamp and a second-type power source connected thereto in the energy recovery circuit are connected to nodes between the one end of the coil and the first-type switches, and
as an operation control in applying the sustain discharge pulses, the LC resonance is generated by turning ON the first-type switch of the energy recovery circuit in a state where the second-type switch of the clamp circuit is turned OFF, and then, at a timing of π/4 or more and less than π/2 of an LC resonance current cycle, the first-type switch is turned OFF, and subsequently, the second-type switch is turned ON, thereby clamping to the high potential or the low potential of the sustain discharge pulse.
